(19) United States
(12) Patent Application Publication
(10) Pub. No.: US 2002/0141762 A1
(43) Pub. Date: Oct. 3, 2002

(54) Administration method and administrative program regarding information on devices connected to network

(76) Inventors: Takayuki Doui, Osaka (JP); Kazutoshi Yu, Kobe-Shi (JP)

Correspondence Address: Platon N. Mandros, BURNS, DOANE, SWECKER & MATHIS, L.L.P., P.O. BOX 1404, Alexandria, VA, 22313-1404, US

(21) Appl. No.: 10/103,719

(22) Filed: Mar. 25, 2002

(30) Foreign Application Priority Data
Mar. 28, 2001 (JP) 2001-93442

(51) Int. Cl. G03G 15/00

(52) U.S. Cl. 399/8

(57) ABSTRACT

An administrative program that causes a computer to perform a step (S3) of requesting the transmission of information regarding the status of a collection flag that indicates the execution of an information collection routine from the administrative apparatuses that can execute an information collection routine in which administrative information is collected from the copying machine connected to the LAN, and a step (S5) of requesting, when information indicating a positive collection flag status is received, the transmission of the collected information from the administrative apparatus from which such information is received.

### This application is based on application No. 2000-093442 filed in Japan, the content of which is hereby incorporated by reference.

### BACKGROUND OF THE INVENTION

1. Field of the Invention

This invention relates to an administrative program, a computer-readable recording medium on which the administrative program is recorded and an administrative apparatus, and more particularly, to an administrative program that is appropriate when multiple administrative apparatuses perform administration regarding the devices connected to a network, as well as to a computer-readable recording medium on which the administrative program is recorded and to an administrative apparatus.

2. Description of the Related Art

Systems currently exist in which copying machines, printers and the like are used while they are connected to a local area network. Such an system includes, in order to administer the multiple printers and copying machines, an administrative personal computer (hereinafter referred to as an ‘administrative apparatus’ ). The administrative apparatus can collect, via a software program, information regarding the status of the multiple printers and copying machines connected to the network at prescribed intervals in order to keep track of the current status of these apparatuses on a real-time basis. This information regarding the status of the multiple printers and copying machines is collected by the administrative apparatus at prescribed intervals through the transmission and receipt of administrative information called MIB. (Management Information Base) using the SNMP (Simple Network Management Protocol) protocol between the administrative apparatus, which administers the multiple printers and copying machines, and the multiple printers and copying machines, which are the objects of administration. Each copying machine or printer is specified by its network address or domain name, and the status information stored in the administrative apparatus regarding each apparatus is associated with such identifying information as the model name and serial number.

The administrative apparatus, which performs administration regarding the printers and copying machines, displays the status of the copying machine or printer, which is specified via a network address or domain name, based on the collected administrative information. As a result, the user of the administrative apparatus can learn on a real-time basis the current status of the multiple printers and copying machines connected to the network.

However, where multiple personal computers that function as administrative apparatuses are connected to a network, each of the multiple administrative apparatuses performs the processing to collect administrative information from the multiple copying machines and printers. Therefore, the same processing is carried out by the multiple administrative apparatuses in a parallel fashion.

On the other hand, the copying machines and printers including the objects of administration must return the same administrative information to the multiple administrative apparatuses. For example, where two administrative apparatuses are connected to a network, administrative information must be returned twice as often as when there is only one administrative apparatus, resulting in an increased load on the copying machines and printers. Further, the problem also exists that as the number of administrative apparatuses connected to a network increases, the network traffic also increases.

### SUMMARY OF THE INVENTION

The present invention is created in order to resolve the problems identified above, and an object thereof is to provide an administrative program that can reduce network traffic and the load on the computer, as well as to a computer-readable recording medium on which such administrative program is recorded.

Another object of the present invention is to provide an administrative program that can cause one computer to collect information even when the administrative program is executed by multiple computers connected to a network, as well as to a computer-readable recording medium on which such administrative program is recorded.

Still another object of the present invention is to provide an administrative program that reliably collects administrative information from the devices connected to a network and can reduce the load on the administrative apparatus and the network, as well as to a computer-readable recording medium on which such administrative program is recorded.

Still another object of the present invention is to provide an administrative apparatus that can reduce traffic on the network and the load thereon.

In order to attain these objects, according to one aspect of the present invention, an administrative program that causes a computer to execute steps of: requesting transmission of identifying information that indicates execution of an information collection routine from a computer connected to a network that is capable of executing a routine to collect information from a device connected to the network; and requesting, when the identifying information is received, transmission of the collected information from the computer which transmits the identifying information.

According to another aspect of the present invention, an administrative program or a computer-readable recording medium on which the administrative program is recorded, the administrative program that causes a computer to execute steps of: requesting transmission of identifying information that indicates execution of an information collection routine from a computer connected to a network that is capable of executing a routine to collect information from a device connected to the network; and collecting information from the device connected to the network in case that the identifying information is not received from any of the computers connected to the network.

According to another aspect of the present invention, an administrative apparatus comprises: a first requesting portion for requesting transmission of identifying information that indicates execution of an information collection routine from an administrative apparatus connected to a network that is capable of executing a routine to collect information from a device connected to the network; and a second requesting portion for requesting transmission of the collected information from the administrative apparatus connected to the network which transmits the identifying information.

According to another aspect of the present invention, a method for administrating information regarding devices connected to a network, comprises steps of: requesting transmission of identifying information that indicates execution of an information collection routine from a computer connected to the network that is capable of executing a routine to collect information from the devices connected to the network; and requesting transmission of the collected information from the computer which transmits the identifying information, when the identifying information is received.

### BRIEF DESCRIPTION OF THE DRAWINGS

These and other objects and features of this invention will become clear from the following description, taken in conjunction with the preferred embodiments with reference to the accompanied drawings in which:

FIG. 1 is a drawing showing the outline of a device administration system of one embodiment of the present invention;

FIG. 2 is a block diagram showing the basic construction of an administrative apparatus in the device administration system of this embodiment;

FIG. 3 is a block diagram showing the basic construction of a copying machine in the device administration system of this embodiment;

FIG. 4 is a flow chart showing the sequence of processes executed in the network administrative program run by the administrative apparatus of this embodiment;

FIG. 5 is a flow chart showing the sequence of processes carried out in the information collection routine executed in step S11 in FIG. 4;

FIG. 6 is a time chart applicable when the network administration operation is executed at different points in time by four administrative apparatuses;

FIG. 7 is a drawing showing the startup flag and collection flag in each of the four administrative apparatuses shown in FIG. 6; and

FIG. 8 is a time chart that applies when the network administration operation is executed at different points in time by two administrative apparatuses.

### DETAILED DESCRIPTION OF THE PREFERRED EMBODIMENTS

An embodiment of the present invention is described below with reference to the drawings. In the drawings, identical reference symbols are used for identical or equivalent members, and explanations of such members will not be duplicated.

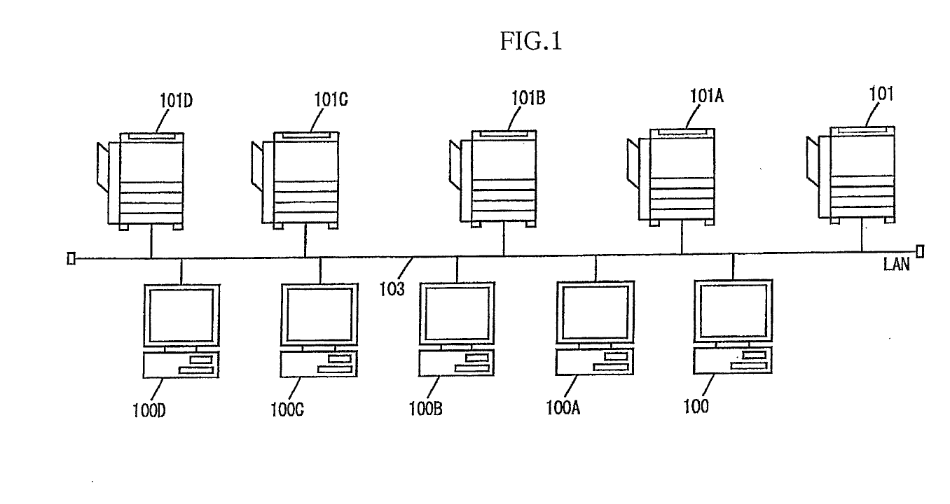

FIG. 1 is a drawing showing the outline of a device administration system including one embodiment. With reference to FIG. 1, the device administration system 1 includes multiple administrative apparatuses 100, 100A, 100B, 100C and 100D, and multiple copying machines 101, 101A, 101B, 101C and 101D, which are administered by the administrative apparatuses.

The administrative apparatuses 100, 100A, 100B, 100C and 100D and the copying machines 101, 101A, 101B, 101C and 101D are connected to a local area network (LAN) 103. Any one of the administrative apparatuses 100, 100A, 100B, 100C and 100D communicates at a given time with each of the copying machines 101, 101A, 101B, 101C and 101D via the LAN 103 based on an administrative program, and the information regarding the status of the copying machines 101, 101A, 101B, 1101C and 101D is collected at prescribed intervals. The status of the copying machines 101, 101A, 101B, 101C and 101D is displayed on the display of the administrative apparatus 100, 100A,00B, 100C or 100D.

The ‘status’ of a copying machine refers, for example, to such states as copying underway, copying stopped or standby. Where the copying machine has stopped copying due to a problem such as a paper jam or toner empty, the information indicating why it has stopped is included in the information indicating that the copying machine has stopped copying. Furthermore, the information regarding the status of a copying machine includes the information that indicates the remaining amount of consumable components, such as the remaining amount of paper and toner.

Any one of the administrative apparatuses 100, 100A, 100B, 100C and 100D communicates at a given time with the multiple copying machines 101, 10A, 101B, 101C and 101D via the administrative program using SNMP, and reads the MIB from each machine at prescribed intervals to collect the status information for each copying machine.

In this embodiment, the objects administered by the administrative apparatus 100 are copying machines, but such object may be any device that is connected to the LAN 103, including a facsimile machine, a printer, an image reader, a multi-function machine including any of these functions together with a copying function, a personal computer, a communication device or a storage device,

Furthermore, while five administrative apparatuses 100, 100A, 100B, 100C and 100D and five copying machines 101, 101A, 101B, 101C and 101D are shown in this embodiment, the number of the administrative apparatuses and the number of objects of administration are not limited to five. In addition, in this embodiment, the administrative apparatuses 100, 100A, 100B, 100C and 100D all perform the same type of processing, and the copying machines 101, 101A, 101B, 101C and 101D also perform the same type of processing. In the following description, an explanation will be provided using the administrative apparatus 100 and the copying machine 101 unless specified otherwise.

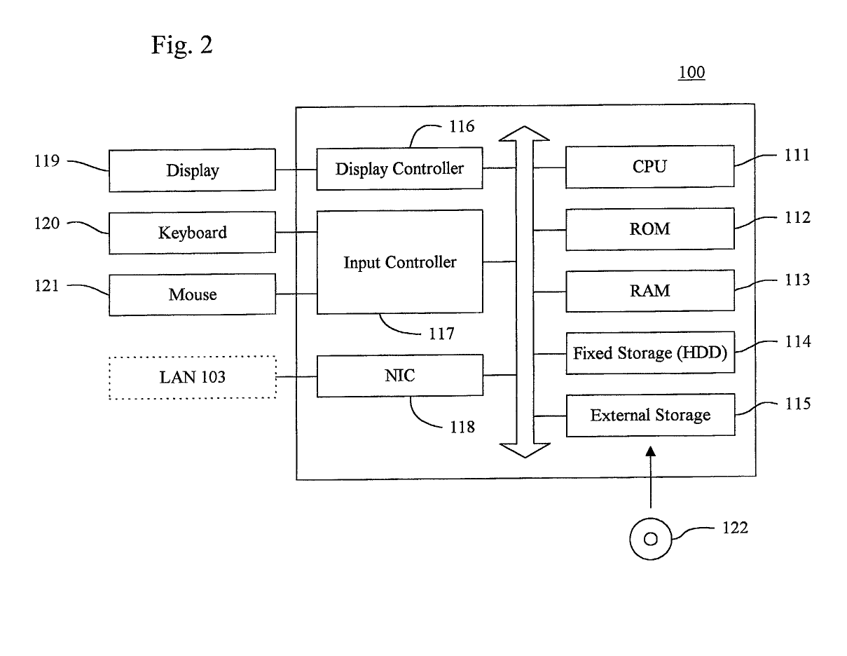

FIG. 2 is a block diagram showing the basic construction of the administrative apparatus 100 of the device administration system 1 of this embodiment. The administrative apparatus 100 includes a personal computer or the like. With reference to FIG. 2, the administrative apparatus 100 includes a central processing unit (CPU) 111 to control the overall operation of the administrative apparatus 100, a read-only memory (ROM) 112 to store programs executed by the CPU 111 therein, a random access memory (RAM) 113 including a working memory needed when the CPU 111 executes a program, a fixed storage device 114 such as a magnetic disk device, an external storage device 115 such as a CD-ROM drive or floppy disk drive, a display controller 116, an input controller 117 and a network interface card (NIC) 118 to connect the administrative apparatus 100 to the LAN 103.

The fixed storage device 114 is a magnetic disk device such as a hard disk drive. The fixed storage device 114 stores programs executed by the CPU 111 as well as necessary information. The fixed storage device 114 also stores information regarding the copying machines including the objects of administration by the administrative apparatus 100. Information regarding a copying machine includes the model name, the serial number and the IP (Internet Protocol) address assigned to the copying machine.

The external storage device 115 reads the programs and data recorded on the computer-readable recording medium 122, and transmits such programs and data to the CPU 111. The external storage device 115 also writes necessary data onto the computer-readable recording medium 122 based on instructions from the CPU 111.

The computer-readable recording medium 122 is a medium that carries a program in a fixed fashion, such as a cassette tape or other magnetic tape, a magnetic disk such as a flexible disk, MD or hard disk, an optical disk or magneto-optical disk such as a CD-ROM, DVD or MO disk, an IC card, or a semiconductor memory such as a mask ROM, EEPROM or flash memory. It may also comprise a recording medium that stores a program in a fluid manner such that the program can be downloaded via a network. For the external storage device, a device that is capable of reading from and writing to the above types of recording media should be used.

The display controller 116 is connected to the display 119 and displays information including characters and/or graphics on the display 119 in accordance with instructions from the CPU 111. The input controller 117 is connected to the keyboard 120 and the mouse 121. The information input from the keyboard 120 and the mouse 121 is sent to the CPU 111.

The network interface card 118 connects the administrative apparatus 100 to the LAN 103. Based on this connection, the administrative apparatus 100 can communicate with any of the multiple copying machines 101, 101A, 101B, 101C and 101D or the other administrative apparatuses 10A, 100B, 100C and 100D via the LAN 103.

The administrative apparatus 100 can function as a Web server based on a Web server program (an administrative program). The administrative apparatus 100 stores a Web page described using HTML (Hypertext Markup Language), for example, in the fixed storage device 114. Where the administrative apparatus 100 functions as a Web server, upon receiving, for example, an HTTP request message based on HTTP from the browser software of the other administrative apparatus 100A, which is a client connected to the LAN 103, the administrative apparatus 100 reads the Web page stored in the fixed storage device 114, and sends it to the administrative apparatus 100A that sent the HTTP request message. The administrative apparatus 100A that received the Web page can display the received Web page in the display area of the browser software on the display after starting up the browser software.

The location on the network of the Web page stored in the fixed storage device 114 is specified via a URL (Uniform Resource Locator). The administrative apparatus 100 reads out the Web page designated by the received HTTP request message, and the administrative apparatus 100 reads out the top page stored in the fixed storage device 114 when the Web page (HTML file) stored in the fixed storage device 114 is not designated,, and sends the Web page read out to the client that sent the HTTP request message. The top page is determined beforehand in accordance with the administrative program in the administrative apparatus 100.

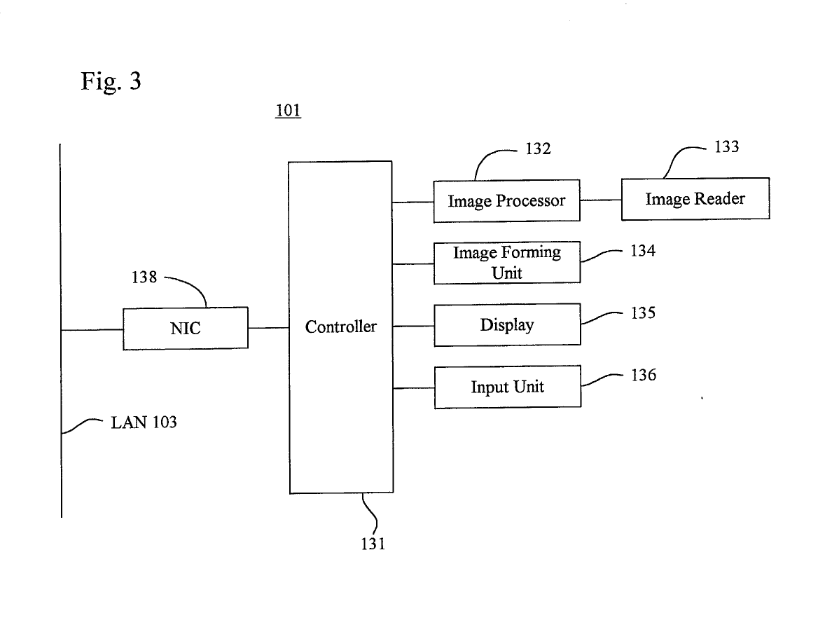

FIG. 3 is a block diagram showing the basic construction of the copying machine in the device administration system of this embodiment. With reference to FIG. 3, the copying machine 101 includes a controller 131 to control the overall operation of the copying machine 101, a image reader 133 to read the image of an original document, an image processor 132 to process the read image data, an image forming unit 134 to render the image data that has undergone image processing into an image formed on a recording medium such as paper, a display 135 to display necessary information thereon, an input unit 136 to input necessary instructions to the copying machine 101, and a network interface card (NIC) 138 to connect the copying machine 101 to the LAN 103.

The controller 131 includes a central processing unit (CPU), a ROM to record programs to be executed by the CPU, and a RAM that is used as a memory area (work area) needed when a program is executed by the CPU.

The image reader 133 irradiates with light the original document to be read, and receives the reflected light via a photoelectric conversion element such as a charge-coupled device (CCD). The received light is converted into electrical signals and sent to the image processor 132 as image data.

The image processor 132 performs necessary image processing to the image data received from the image reader 133 or the image data sent from a personal computer or the like via the NIC 138 or the LAN 103. The image data that has undergone image processing by the image processor 132 is sent to the image forming unit 134.

The image forming unit 134 forms an image on a recording medium including paper or the like using the image data received from the image processor 132.

The display 135 displays menu screens to perform mode setting for the copying machine 101, the operation mode currently active in the copying machine 101, and other information.

The input unit 136 includes a numerical keypad, touch panel or the like, and is used to input necessary instructions in the copying machine 101.

The NIC 138 is an interface to connect the copying machine 101 to the LAN 103. The copying machine 101 can communicate with the administrative apparatus 100 via the NIC 138.

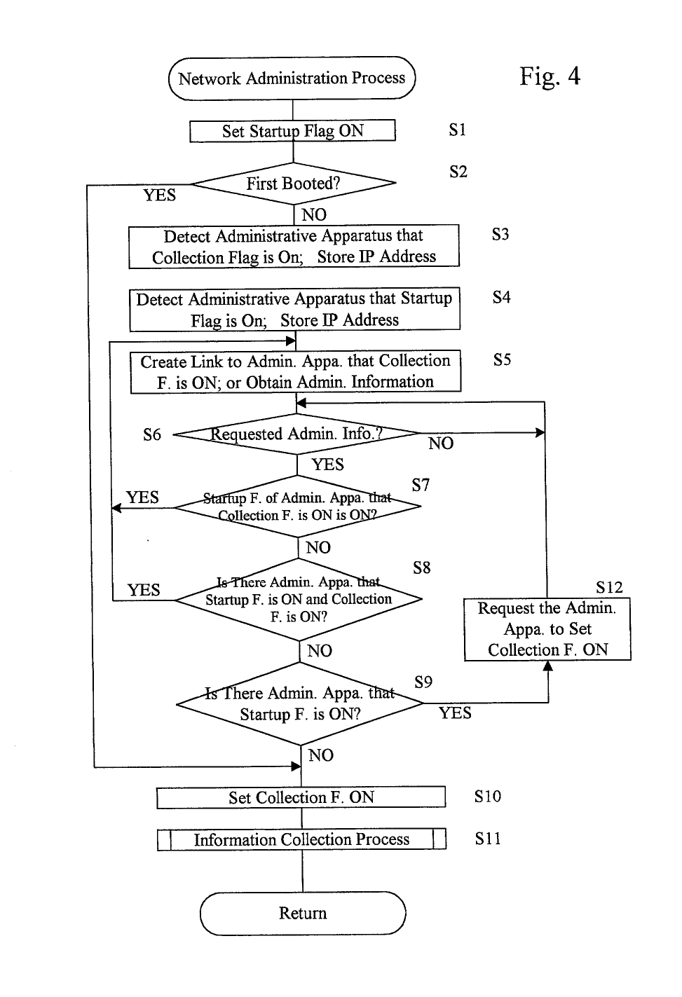

FIG. 4 is a flow chart showing the sequence of processes executed in the network administration program run by the administrative apparatus 100 of this embodiment. The network administration operation is performed when the CPU 111 runs the network administration software program stored in the ROM 112 or fixed storage device 114 of the administrative apparatus 100. The same administrative program is being or may be run by the administrative apparatuses 100A through 100D as well at any given time.

With reference to FIG. 4, in the network administration operation, a startup flag is first set to ON (step S1). A startup flag is a flag that indicates that a network administration operation is being performed by the administrative apparatus 100. When this flag is ON, it means that the administrative apparatus 100 is in a state in which the top page may be sent. The location of the HTML file, which is the top page, is specified on the network via the URI (Uniform Resource Identifier) of ‘http://(IP address)/index.html’, for example. Here, the IP address is the network address assigned to the administrative apparatus 100 beforehand.

More specifically, when the startup flag is ON, that means that the top page is stored in a prescribed storage area of the fixed storage device 114. Moreover, when the startup flag is ON, that also means that the administrative apparatus 100 is working as a Web server.

In the next step S2, it is determined whether or not the network administration program of the administrative apparatus 100 is booted first among the administrative apparatuses 100, 100A, 1003B, 100C and 100D connected to the network. If it is determined that the network administration program of the administrative apparatus 100 is booted first, the CPU advances to step S10, and if not, it advances to step S3.

The determination as to whether the network administration program of the administrative apparatus 100 is booted first is made via the following procedure. First, a connection is created to the other administrative apparatuses 100A, 100B, 100C and 100D connected to the LAN 103 using HTTP, and an HTTP request message is sent to each of these other apparatuses. The URI designated by the HTTP request message is an URI to designate the top page held in each administrative apparatus. The URI for the top page of each administrative apparatus is defined via ‘http://(IP address of each administrative apparatus)/index.html’. A URI that specifies the top page of the administrative apparatus 100A is obtained by entering the IP address of the administrative apparatus 100A in the IP address field of the above URI. Similarly, by inserting the IP address of the administrative apparatus 100B, 100C or 100D in the IP address field of the above URI, an URI that specifies the top page of each administrative apparatus 100B, 100C or 100D is obtained. The URIs for the other administrative apparatuses 100A, 100B, 100C and 100D are stored beforehand in the fixed storage device 114 of the administrative apparatus 100.

When the URIs that respectively specify the top page of the other administrative apparatus 100A, 100B, 100C and 100D are designated and an HTTP request message is sent to each apparatus, the administrative apparatus that received the HTTP request message sends the top page to the administrative apparatus 100, if the top page can be sent. If the top page cannot be sent, no top page is sent back. Situations in which the top page cannot be sent include, for example, a situation in which the top page is not stored in the prescribed area of the fixed storage device 114, or a situation in which the administrative apparatus is not working as a Web server. As described above, if an administrative apparatus can send the top page, that means that the startup flag is ON in that apparatus, while if an administrative apparatus cannot send the top page, that means that the startup flag is OFF or that the administration program is not running. Therefore, when the top page is received, it is determined that the startup flag of the administrative apparatus from which the Web page is received is ON, and if the top page is not received, it is determined that the startup flag of the administrative apparatus is OFF.

In step S2, if none of the other administrative apparatuses 100A, 100B, 100C or 100D sends back its top page, the CPU determines that the network administration program of the administrative apparatus 100 is booted first among all the administrative apparatuses, and advances to step S10. Conversely, where one or more of the other administrative apparatuses 100A, 100B, 100C and 100D returns the top page, the CPU determines the administration program is not first boot and the CPU advances to step S3.

In step S3, the administrative apparatuses in which a collection flag is ON are detected, and the IP addresses of the detected apparatuses are stored in the fixed storage device 114. A collection flag is a flag that is ON at all times while the information collection routine in step S11, which is described below, is being performed, and is OFF at all times while the information collection routine is not being performed.

When the collection flag is ON, that indicates a state in which the specified Web page of the administrative apparatus 100 may be sent. The location of the HTML file that includes the specified Web page is specified on the network via the URI (Uniform Resource Identifier) of ‘http:/H(IP address)/flag.html’, for example. Here, the IP address includes the network address assigned to the administrative apparatus 100 beforehand.

More specifically, where the collection flag is ON, that means that the specified Web page is stored in a prescribed storage area of the fixed storage device 114. Moreover, where the collection flag is ON, that means that the specified Web page may be sent when an HTTP request message designating the URI of ‘http:/H(IP address)/flag.html’ is received by the administrative apparatus 100.

Where the specified Web page is received, the administrative apparatus 100 determines that the collection flag of the administrative apparatus from which the Web page is received is ON. The IP address of the administrative apparatus from which the specified Web page is received is stored in the fixed storage device 114 of the administrative apparatus 100.

It is determined in step S2 whether or not the startup flags of the other administrative apparatuses 100A, 100B, 100C and 100D connected to the LAN 103 are ON. Based on the information obtained in the process of step S2, the IP addresses of the administrative apparatuses in which the startup flags are ON are stored in the fixed storage device 114 of the administrative apparatus 100. Consequently, the IP addresses of the administrative apparatuses in which the startup flags are ON when the network administration operation is begun by the administrative apparatus 100 are stored in the fixed storage device 114.

In step S4, the IP addresses of the administrative apparatuses in which the startup flags are ON are stored when the network administration program is booted in the administrative apparatus 100. In other words, the IP addresses of the administrative apparatuses on which the network administration program is already running before the network administration program is booted in the administrative apparatus 100 are stored. Therefore, the IP addresses of the administrative apparatuses that booted the network administration program earlier are stored.

As described below, only one administrative apparatus at most among the administrative apparatuses 100, 100A, 100B, 100C and 100D connected to the LAN 103 has its collection flag ON at any given time.

In the next step S5, in the Web page of the administrative apparatus 100, a link is established to the administrative apparatus in which the collection flag is ON, or the administrative information is obtained from that administrative apparatus in which collection flag in ON.

The information collection routine is carried out by the administrative apparatus in which the collection flag is ON. Where a link is established, the administrative information is collected from the copying machines 101, 101A, 101B, 101C and 101D by the administrative apparatus in which the collection flag is ON, and a Web page that shows the status of each of the copying machines is created based on the collected administrative information. This Web page is created as an HTML file, and is a Web page to display the status of the copying machines. The HTML file, which includes a status display Web page, is stored in a prescribed area of the fixed storage device 114 of the administrative apparatus in which the collection flag is ON. Here, the URI that specifies the status display Web page is ‘http://(IP address)/status.html’. The IP address includes the network address of the administrative apparatus that is executing the information collection routine (i.e., the administrative apparatus in which the collection flag is ON). If the collection flag is ON in the administrative apparatus 100, the other administrative apparatuses 100A, 100B, 100C and 100D create a link to the administrative apparatus 100 using the URI that specifies the status display Web page. In other words, the other administrative apparatus 100A, 100B, 100C or 100D sends an HTTP request message designating the status display Web page to the administrative apparatus 100 when the link such as ‘http://(IP address/status.html’ displayed on the display is clicked on using a mouse or the like, and the status display Web page created by the administrative apparatus 100 is received. The received status display Web page is displayed on the display of the receiving administrative apparatus.

In the process in which the administrative information is obtained, the collected administrative information is sent to the administrative apparatuses in which the collection flags are OFF from the administrative apparatus in which the collection flag is ON using a specified protocol on top of TCP/IP. Consequently, the administrative apparatuses that are not performing the information collection routine obtain the administrative information from the administrative apparatus in which the collection flag is ON. The administrative apparatuses in which the collection flags are OFF create a display screen that indicates the status of each copying machine 101, 101A, 101B, 101C and 101D based on the collected administrative information, and display the display screen on their respective display.

In the next step S6, it is determined whether or not a request for administrative information has been received. If a request for administrative information has been received, the CPU advances to step S7, and if has not received, the CPU is standby. A request for administrative information may be issued at certain intervals, or alternatively, may be issued based on the input of a prescribed instruction by the user of the administrative apparatus 100 via the keyboard 120 or the mouse 121, for example. A prescribed instruction may comprise, for example, an instruction that instructs that the status of the copying machines be displayed.

In the next step S7, it is determined whether or not the startup flag of the administrative apparatus in which the collection flag is detected to be ON in step S3 is ON. This determination is made based on whether or not the specified Web page is received after the transmission of a HTTP request message that designates the specified Web page URI to the administrative apparatus in which the collection flag is ON, which is specified by the IP address stored in step S3. If the specified Web page is received, the CPU advances to step S5, and if not received, the CPU advances to step S8.

Where the startup flag is not ON but OFF, that means that the network administration program is no longer running in that administrative apparatus. Therefore, that administrative apparatus is not performing the information collection routine. Therefore, it is necessary to look for another administrative apparatus that is executing the information collection routine.

In step S8, it is determined based on the IP addresses stored in step S4 whether or not there is an administrative apparatus, among the administrative apparatuses in which the startup flags are ON, in which the collection flag is ON. If there is such an apparatus, the CPU advances to step S5, and if not, the CPU advances to step S9. The process of step S8 is carried out by sending to each administrative apparatus specified by the IP addresses stored in step S4 an HTTP request message that designates the specified Web page URI. Where a specified Web page is received from any of the administrative apparatuses, it is determined that an administrative apparatus exists in which the collection flag is ON, and if not, it is determined that none of the administrative apparatuses has its collection flag ON.

The situation in which a specified Web page is not received from any of the administrative apparatuses includes a situation in which none of the administrative apparatuses that booted the network administration operation is performing the information collection routine. In other words, this situation is equivalent to a situation in which this administrative apparatus 100 (or the program) is the first one that is booted.

Where a specified Web page is received from one of the administrative apparatuses that booted the network administration operation earlier, that means that the collection flag of the administrative apparatus from which the specified Web page is received is ON. When this occurs, because the administrative apparatus in which the collection flag is ON is performing the information collection routine, a link is created in step S5 from the administrative apparatus 100 in which this program is being executed to the administrative apparatus in which the collection flag is ON, or alternatively, the administrative information is obtained from the administrative apparatus in which the collection flag is ON.

In step S9, it is determined whether or not an administrative apparatus in which the startup flag is still ON exists among the administrative apparatuses specified via the IP addresses stored in step S4. Where no such administrative apparatus exists, the CPU advances to step S10, and where there is such an apparatus, the CPU advances to step S12. ‘Administrative apparatuses specified via the IP addresses stored in step S4 include the administrative apparatuses that booted the network administration program earlier.

In step S10, the collection flag is turned ON. This is done by storing the specified Web page specified via the URI of ‘http://(IP. address/flag.html’ in a prescribed area of the fixed storage device 114.

In the next step S11, the information collection routine is executed.

On the other hand, where an administrative apparatus in which the startup flag is still ON is determined to exist among the administrative apparatuses specified via the IP addresses stored in step S4, a request that the collection flag be raised is sent to that administrative apparatus in step S12.

In other words, the request issued in step S12 that the collection flag be raised is sent to an administrative apparatus in which the network administration program is booted earlier, and the administrative apparatus that will have its collection flag ON is the one that booted the network administration program earlier. After the process of step S12 is executed, the CPU advances to step S6.

As described above, regarding the administrative apparatuses of this embodiment, even when the network administration program is booted in multiple administrative apparatuses connected to a network, the information collection routine is performed only by the administrative apparatus on which the network administration program is first booted. Therefore, the information collection routine is not executed by the multiple administrative apparatuses connected to the network at a given time, and the load on the administrative apparatuses that are not executing the information collection routine may be reduced.

In addition, because only one administrative apparatus executes the information collection routine, network traffic is also reduced. Furthermore, because the number of requests sent from the administrative apparatuses asking that administrative information be sent is reduced, the load on the copying machines may also be reduced.

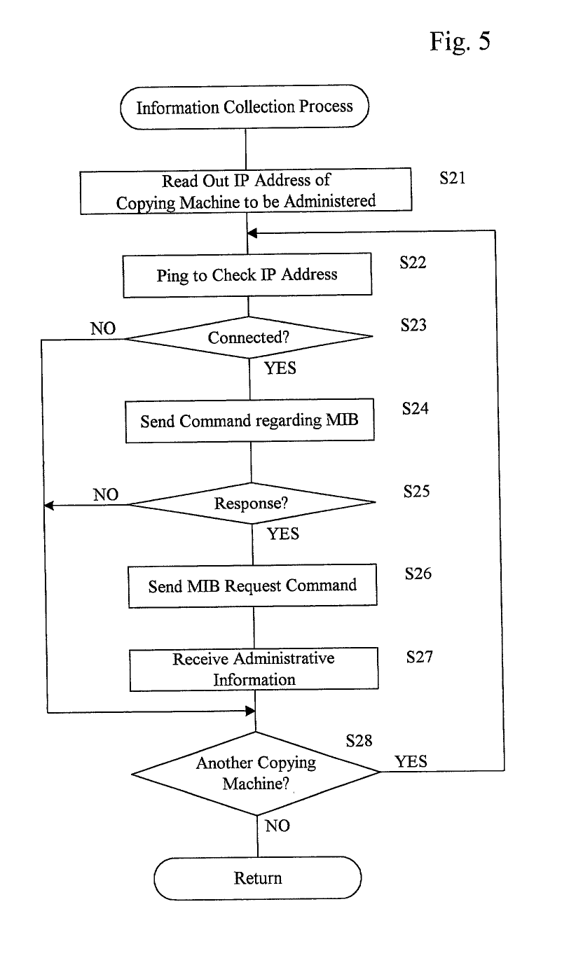

FIG. 5 is a flow chart showing the sequence of processes of the information collection routine executed in step S11 of FIG. 4. With reference to FIG. 5, in the information collection routine, the IP addresses of the copying machines including the objects of administration, which are stored beforehand in the fixed storage device 114 of the administration apparatus 100, are first read out (step S21). The ‘copying machines including the objects of administration’ are those copying machines among the copying machines connected to the LAN 103 that are being administered by the administrative apparatus 100. As shown in FIG. 1, five copying machines 101, 101A, 101B, 101C and 101D are connected to the LAN 103. All five copying machines may be administered by the administrative apparatus 100, or alternatively, a smaller number of copying machines may be the objects of administration.

In step S22, it is determined by pinging whether or not the copying machines that are specified as the objects of administration are running. That is, it is checked whether each copying machine administered by the administrative apparatus 100 is connected to the network. The copying machines including the objects of administration are identified by pinging based on the IP addresses that are read out.

After the connection to the network is checked in step S23, if connection is confirmed, the CPU advances to step S24, and if connection is not confirmed, the CPU advances to step S28.

In the next step S24, a command regarding the MIB is sent to each copying machine to be processed.

It is then determined in step S25 whether or not a response is received to the command regarding the MIB. Where a response is received, the CPU advances to step S26, and if not, it advances to step S28.

If a response is received to the transmission of a command regarding the MIB, it is determined that the device that returned the response is a device including an object of administration, and a response is not received, the device is determined to fall outside the scope of devices being administered by the administrative apparatus 100.

An MIB request command is sent in the next step S26, and administrative information is received in the following step S27. The administrative information thus received is stored in the fixed storage device 114.

In the next step S28, it is determined whether or not copying machines exist, among the copying machines read out in step S21 as including the objects of administration, regarding which the processes of the steps S22 through S27 have not been performed. If such copying machines exist, the CPU advances to step S22 to process the next copying machine as an object of administration. If not, the CPU ends the routine.

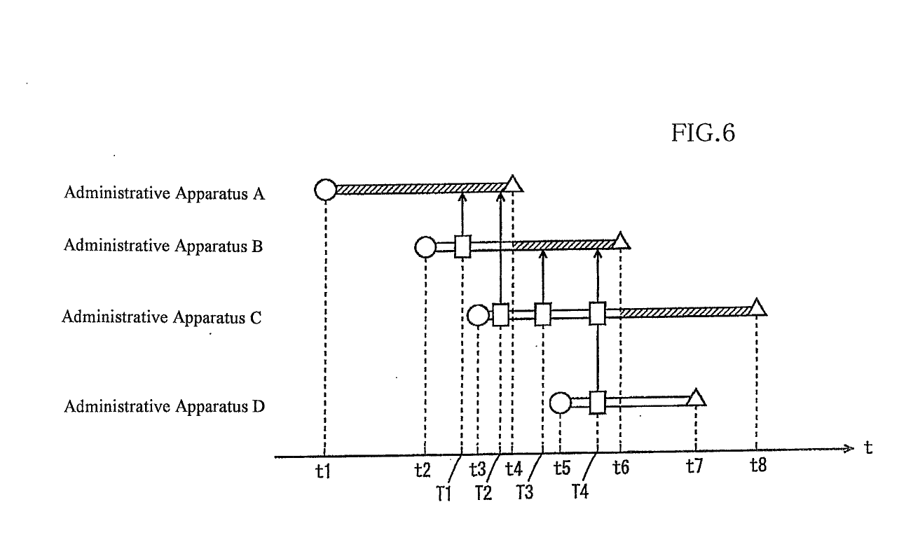

FIG. 6 is a time chart showing the situation in which network administration operation is performed at different points in time by four administrative apparatuses. In FIG. 6, the horizontal axis in the graph is the time axis.

Regarding the administrative apparatuses A, B, C and D, the point at which the network administration operation is begun is indicated by a circle, and the point at which the operation is finished is indicated by a triangle. The shaded area representing the period of time between the circle, which indicates the beginning, and the triangle, which indicates the end, is the period during which the information collection routine is being performed.

Regarding the administrative apparatus A, the network administration operation is begun at time t1 and finished at time t4. The information collection routine is also begun at time t1 and finished at t4.

Regarding the administrative apparatus B, the network administration operation is begun at time t2 and finished at time t6. The information collection routine is begun at time t4 and finished at time t6.

Regarding the administrative apparatus C, the network administration operation is begun at time t3 and finished at time t8. The information collection routine is begun at time t6 and finished at time t8.

Regarding the administrative apparatus D, the network administration operation is begun at time t5 and finished at time t7. It does not perform the information collection routine.

As is clear from FIG. 6, only one administrative apparatus performs the information collection routine at any given point in time. For example, during the period from time t2 to time t4, the network administration operation is being performed by the administrative apparatus A and the administrative apparatus B, but the information collection routine is being carried out by the administrative apparatus A only. Similarly, during the period from time t5 to time t6, the network administration operation is being performed by the administrative apparatuses B, C and D, but the information collection routine is being executed by the administrative apparatus B only.

In addition, the administrative apparatus that performs the information collection routine is that which began the network administration operation the earliest. For example, during the period from time t3 to time t4, the administrative apparatuses A, B and C are performing the network administration operation. At time t4, the administrative apparatus A finishes the network administration operation, whereupon the information collection routine is finished as well. In this case, the information collection routine is performed next by the administrative apparatus B, which began performing the network administration operation earlier than the administrative apparatus C.

Where the administrative apparatuses A, B, C and D perform the operation based on the time chart shown in FIG. 6, the information collection routine is not being performed by the administrative apparatus B at time T1. Therefore, a link is established to the administrative apparatus A or the administrative information is received from the administrative apparatus A. At time T2, the information collection routine is not being performed by the administrative apparatuses B or C. Therefore, a link is established to the administrative apparatus A, which is performing the information collection routine, or the administrative information is received from the administrative apparatus A. At time T3, the information collection routine is not being performed by the administrative apparatus C. Therefore, a link is established to the administrative apparatus B, which is carrying out the information collection routine, or the administrative information is received from the administrative apparatus B. At time T4, the information collection routine is not being carried out by the administrative apparatuses C or D. Therefore, a link is established to the administrative apparatus B, which is performing the information collection routine, or the administrative information is received from the administrative apparatus B.

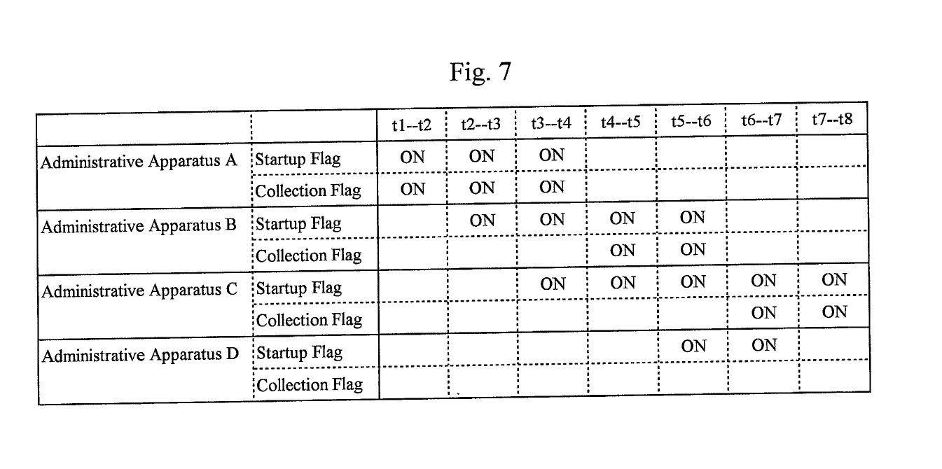

FIG. 7 is a drawing showing the status of the startup flag and the collection flag of each of the four administrative apparatuses shown in FIG. 6. FIG. 7 shows the status of the startup flag and the collection flag for each administrative apparatus A, B, C and D in the periods t1-t2, t2-t3, t3-t4, t4-t5, t5-t6, t6-t7 and t7-t8. The chart indicates ‘ON’ if the flag is ON, and a blank cell indicates that the corresponding flag is OFF. As is clear from FIG. 7, only one administrative apparatus has the collection flag ON in each of the above periods.

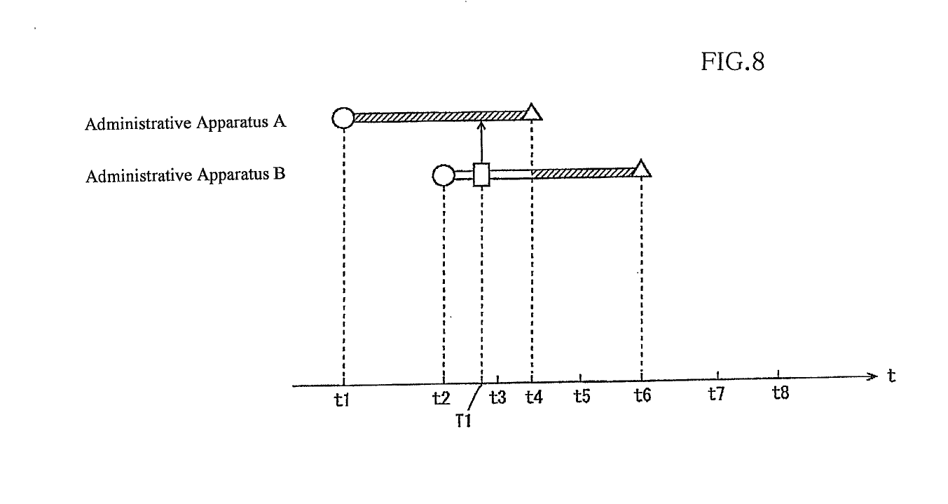

FIG. 8 is a time chart applicable when two administrative apparatuses perform the network administration operation at different points in time. In FIG. 8, the horizontal axis is the time axis.

Regarding the administrative apparatuses A and B, the point at which the network administration operation is begun is indicated by a circle, and the point at which the operation is finished is indicated by a triangle. The shaded area representing the period of time between the circle, which indicates the beginning, and the triangle, which indicates the end, is the period during which the information collection routine is being performed.

Regarding the administrative apparatus A, the network administration operation is begun at time t1 and finished at time t4. The information collection routine is also begun at time t1 and finished at t4 as well.

Regarding the administrative apparatus B, the network administration operation is begun at time t2 and finished at time t6. The information collection routine is begun at time t4 and finished at time t6.

As is clear from FIG. 8, only one administrative apparatus is performing the information collection routine at any given point in time. For example, during the period from time t2 to time t4, the network administration operation is being performed by the administrative apparatuses A and B, but the information collection routine is being carried out by the administrative apparatus A only.

Moreover, the administrative apparatus that performs the information collection routine is that in which the network administration operation is begun earlier. For example, during the period from time t2 to time t4, both of the administrative apparatuses A and B are performing the network administration operation, but the information collection routine is being executed by the administrative apparatus A only, which began the network administration operation first.

Where the administrative apparatuses A and B perform the operation in accordance with the time chart shown in FIG. 8, the information collection routine is not being performed by the administrative apparatus B at time T1. Therefore, a link is established to the administrative apparatus A, or alternatively, the administrative information is received from the administrative apparatus A.

As explained above, using the administrative apparatuses of this embodiment, the information collection routine is performed by an administrative apparatus in which the collection flag is ON, and administrative apparatuses in which the collection flag is OFF receive the administrative information from the administrative apparatus in which the collection flag is ON. Because administrative information is received from the administrative apparatus that is performing the information collection routine, as described above, the number of computers that execute the information collection routine at any given time on the network may be limited to a single computer.

In addition, because the information collection routine is executed by the computer that began the network administration program earlier than the others, even where the network administration program is executed by multiple administrative apparatuses connected to a LAN 103, the information collection routine can be performed by only one administrative apparatus.

Furthermore, because when the program in which the information collection routine is being performed is finished and the startup flag of the administrative apparatus that is running the above program became OFF, the collection flag of the administrative apparatus in which the network administration program is booted next becomes ON and the information collection routine is performed by that apparatus, the information collection routine may be executed by one of the administrative apparatuses that are carrying out the network administrative operation.

As described above, the collection flag becomes ON in the administrative apparatus in which the program is first booted and information is collected. When the program in the administrative apparatus in which the collection flag is ON is finished, the collection flag of the administrative apparatus in which the network administration program is booted next becomes ON and information is collected. Therefore, the administrative apparatus in which the administrative program is first booted performs information collection at all times, and the other administrative apparatuses establish a link to the administrative apparatus that is collecting information, or alternatively, they receive the information from the administrative apparatus that is actively collecting information. Therefore, administrative information may be reliably collected, and the load on the administrative apparatuses and the network may be reduced.

The embodiment disclosed herein is an example in every aspect thereof, and should be interpreted as not restrictive. The scope of the present invention is indicated not by the description provided above but by the claims, and it is intended that all modifications within the meaning and scope equivalent to the claims be included therein.

What is claimed is:

1. An administrative program that causes a computer to execute steps of:
requesting transmission of identifying information that indicates execution of an information collection routine from a computer connected to a network that is capable of executing a routine to collect information from a device connected to the network; and
requesting, when the identifying information is received, transmission of the collected information from the computer which transmits the identifying information.

2. The administrative program according to claim 1, further causes the computer to execute a step of
collecting information from the device connected to the network, when the collected information is not received from the computer which transmits the identifying information.

3. The administrative program according to claim 1,
wherein in the step of requesting the transmission of the identifying information, further requesting transmission of the identifying information from another computer connected to the network, in case that the collected information cannot be received from the computer which transmits the identifying information.

4. The administrative program according to claim 3,
further comprising a step of detecting another computer that is executing a administrative program from among other computers connected to the network, and
wherein in the step of requesting the transmission of the identifying information, requesting transmission of the identifying information from the detected computer.

5. The administrative program according to claim 3,
further comprising a step of collecting information from the device connected to the network, when the identifying information is not received from any of the computers.

6. An administrative program that causes a computer to execute steps of:
requesting transmission of identifying information that indicates execution of an information collection routine from a computer connected to a network that is capable of executing a routine to collect information from a device connected to the network; and
collecting information from the device connected to the network in case that the identifying information is not received from any of the computers connected to the network.

7. A computer-readable recording medium on which the administrative program of claim 1 is recorded.

8. An administrative apparatus comprising:
a first requesting portion for requesting transmission of identifying information that indicates execution of an information collection routine from an administrative apparatus connected to a network that is capable of executing a routine to collect information from a device connected to the network; and
a second requesting portion for requesting transmission of the collected information from the administrative apparatus connected to the network which transmits the identifying information.

9. A method for administrating information regarding devices connected to a network, comprising steps of:
requesting transmission of identifying information that indicates execution of an information collection routine from a computer connected to the network that is capable of executing a routine to collect information from the devices connected to the network; and
requesting transmission of the collected information from the computer which transmits the identifying information, when the identifying information is received.

10. A method of administrative information for an information administrative apparatus, comprising steps of:
requesting transmission of identifying information that indicates execution of an information collection routine from a computer connected to a network that is capable of executing a routine to collect information from a device connected to the network; and
collecting information from the device connected to the network in case that the identifying information is not received from any of the computers connected to the network.
